(19) United States
(12) Patent Application Publication
(10) Pub. No.: US 2017/0119023 A1
(43) Pub. Date: May 4, 2017

(54) Soluble Fiber Liquid Beverage Concentrate And Method For Delivery Of Soluble Fiber

(71) Applicant: Medtech Products Inc., Tarrytown, NY (US)

(72) Inventors: Josef V. Knutzen, Allendale, NJ (US); Bryan Duke, New York, NY (US); James D. Hammer, Uxbridge, MA (US)

(73) Assignee: Medtech Products Inc., Tarrytown, NY (US)

(21) Appl. No.: 15/143,674

(22) Filed: May 2, 2016

Related U.S. Application Data
(60) Provisional application No. 62/249,000, filed on Oct. 30, 2015.

(51) Int. Cl. A23L 2/00; A23L 2/68; A23L 2/60; A23L 2/46; A23L 2/385; A23L 2/56

(52) U.S. Cl. CPC A23L 1/3081; A23L 1/3088; A23L 1/293; A23L 2/385; A23L 2/68; A23L 2/56; A23L 2/60; A23L 2/46; A23V 2002/00

(57) ABSTRACT

A flavored, fiber-enriched liquid beverage concentrate of an acidulant, a flavor, a high-intensity sweetener, a dietary fiber, and water, the dietary fiber comprising about 20 to 60 percent by weight of the concentrate volume with a pH in a range of about 1.4 to about 4.0. A method of delivering dietary fiber from a liquid beverage concentrate is disclosed.

### TECHNICAL FIELD

The present invention relates to edible products and methods for providing soluble dietary fibers to persons as a nutritional supplement. More particularly, the present invention relates to soluble dietary fiber liquid beverage concentrates and methods for delivery of soluble fibers for nutritional supplements for persons.

### BACKGROUND OF THE PRESENT INVENTION

Edible fibers are one of many important food components that contribute to healthy physiological biometrics of youths and adults. Such fibers contribute to the nutritional processing and digestion of foods and to the elimination of solid wastes from foods. Edible fibers found in foods are of a soluble type and an insoluble type. Soluble fibers attract and absorb water. Soluble fibers absorb water while passing through a person's gastrointestinal tract including the stomach and intestines. This effects a reduction in the digestion process of foods, delays emptying of the stomach, and contributes to a sense that one is full while eating foods. As a result, a person feeling full may eat less and this helps control weight gain. Soluble fibers within a lower intestinal tract also contribute to consistency of stool formation and elimination. Suitable amounts of dietary soluble fibers have smoothing or balancing effects on bowel actions of a person by reducing by both constipation and diarrhea in waste elimination functions. These problems of stools being excessively dense or excessively fluid are referenced generally as irritable bowel syndrome. Further, soluble fiber within a dietary regime is considered as having favorable effects on blood sugar levels, insulin sensitivity and LDL cholesterol.

In 2006, and subsequently available annually, the National Academy of Sciences, Institute of Medicine promulgated suggested dietary intakes in a guide to nutrient requirements. The Institute recommends that male adults (over age 14 and less than age 50) consume about 38 g/day of total dietary fiber comprising both soluble and insoluble fibers; the recommendation for female adults is about 25 g/day total dietary fiber. For younger male children (over age 1), the recommendation ranged from about 19 g/day total dietary fiber, over age 4 at about 25 g/day total dietary fiber, and over age 9, about 31 g/day total dietary fiber. For younger female children (over age 1), the recommendation ranged from about 19 g/day total dietary fiber and over age 4 at about 25 g/day total dietary fiber. However, reports suggest that many persons consume less than half of the recommended dietary fibers.

Accordingly, there is a need in the art for an edible food containing soluble fibers and a method of delivering soluble fibers to persons as a nutritional supplement. It is to such that the present invention is directed.

### SUMMARY OF THE PRESENT INVENTION

The present invention meets the need in the art by providing a flavored, fiber-enriched liquid beverage concentrate, comprising an acidulant, a flavor, a high-intensity sweetener, a soluble dietary fiber, and water, the soluble fiber comprising about 20 to 60 percent by weight of the concentrate volume with a pH in a range of about 1.2 to about 4.0.

In another aspect, the present invention provides a method of delivering a soluble dietary fiber for human consumption, comprising the steps of:

(a) providing a beverage concentrate comprising an acidulant, a flavor, a high-intensity sweetener, a soluble dietary fiber, and water, the soluble fiber comprising about 20 to 60 percent by weight of the concentrate volume with a pH in a range of about 1.2 to about 4.0; and

(b) admixing the beverage concentrate with water to a volume in a range of about 4 ounces to about 16 ounces.

Objects, advantages, and features of the present invention may be readily determined upon a reading of the detailed description in conjunction with the drawings and the appended claims.

### DETAILED DESCRIPTION

The present invention provides a flavored, fiber-enriched liquid beverage concentrate, comprising an acidulant, a flavor, a high-intensity sweetener, a soluble dietary fiber, and water, the soluble fiber comprising about 20 to 60 percent by weight of the concentrate volume with a pH in a range of about 1.2 to about 4.0.

Preparation of the liquid concentrate involves mixing of the water carrier with the constituents, for example, in sequence of a preservative (if any), the sweetener, the soluble fiber, the flavoring, coloring (if any), and the acidulant.

A packaging for the liquid concentrate preferably contains a plurality of servings although the liquid concentrate may in an alternate embodiment be provided in a single-serving package.

The packaging dispenses a serving amount for dilution in added water content. A serving amount of the illustrated embodiments is about 7 to 11 grams or about 1.5 teaspoon, preferably about 9.5 grams, and delivering about 2.5 grams to about 4 grams soluble dietary fiber, preferably about 3 grams of soluble dietary fiber.

Soluble fibers useful with embodiments of the present invention include vegetable fibers of types that desirably solubilize completely in water to yield a clear to almost clear liquid product, as well as fruit fiber, grain fibers, water-swellable fibers including galactomannan and hydrocolloids, natural soluble fibers and synthetic soluble fibers that solubilize to yield the desirable clear liquid product.

Vegetable sources having appropriate fiber properties include pea, carrot, soy and potato, as well as microcrystalline cellulose.

Fruit sources having soluble fibers include apple, tomato and berries. A natural hydrocolloid pectin provides a soluble fiber source.

While grain fibers are primarily insoluble, some grain fibers have satisfactory properties for use with the liquid beverage concentrate of the present invention. Grain fibers could also be processed to improve solubility. These grain fibers include oat, wheat, oat bran, barley and corn.

Galactomannan and hydrocolloids water-swellable fibers useful with the present invention include pectin, guar, carrageenan, tragacanth, alginate, konjac and psyllium. Synthetic water-swellable fibers include carboxymethylcellulose, methycellulose, hydroxpropylmethylcellulose, and hydroxypropylcellulose.

Natural fibers that solubilize and yield a clear liquid include soluble corn fiber, maltodextrin and acacia, and particularly acacia prepared as a low viscosity hydrocolloid, and hydrolyzed guar gum.

Synthetic soluble fibers include polydextrose, modified food starch, and similar. More particularly, food grade sources of soluble fiber useful in embodiments of the present invention include corn fiber, barley, corn germ, ground oat hulls, milled corn bran, derivatives of the aleurone layer of wheat bran, flax flour, whole flaxseed bran, milled flaxseed bran, winter barley flake, ground course kilned oat groats, maize, pea fiber, canadian yellow pea, danish potatoes, konjac vegetable fiber, psylliumfiber from seed husks of planago ovate, psyllium husk, liquid agave fiber, rice bran, oat sprout fibers, amaranth sprout, lentil flour, grape seed fiber resulting from fine milling, apple, blueberry, cranberry, fig fibers, ciranda power, carob powder, milled prune fiber, mixed mango and apple fiber, orange, orange pulp, strawberry, carrageenan hydrocolloid, derivatives of eucheuma cottonnil seaweed, cottonseed, soya, kiwi, acacia gum fiber, bamboo, chia, potato, potato starch, pectin (carbohydrate) fiber, hydrolyzed guar gum, carrot, soy, soybean, oat, wheat, tomato, polydextrose fiber, refined corn starch syrup, multi-fruit seed blends, isomalto-oligosaccharide mixtures, dehulled seeds of pulse crops, soluble dextrin derived from corn starch, course hemp powder, mixtures of citrus bioflavonoids, mixtures of citrus bioflavonoids comprising mainly hesperidin, mixtures of citrus bioflavonoids and dietetic fibers such as orange, grapefruit or lemon, cell-wall broken nutritional yeast, lipophilic fibers, plum juice, derivatives from larch trees, highly branched polysaccharide, highly branched polysaccharide composed of glaactose and arabinose, highly branched polysaccharide composed of glaactose, arabinose and polyphenols, yeast from saccharomyces cerevisiae, olygose fibers, derivatives from cane sugar, short-chain fructooligosaccharides, synthetic polymers of glucose, polydextrose, pectin, polanion compounds, natural 5-carbon sugars, cellulose fibers, cellulose fibers derived from hard wood plants, carboxymethyl cellulose, and fat replacement products.

It is to be appreciated that some of the foregoing sources of soluble fiber include both soluble and insoluble components. It is expected that sources with relatively higher amounts of insoluble components are less desirable for the fiber-enriched liquid beverage concentrate of the present invention, and such sources may require separate processing for extraction and/or separation of the insoluble components for use of the source for soluble fibers in the beverage concentrate.

Suitable fiber sources useful with embodiments of the present invention are of types providing application characteristics and properties of a combination of high fiber content, high solubility with low viscosity, low flavor impact, low pH tolerance. Other desirable characteristics include sources that are readily available from a range of reliable providers and relatively low comparative costs. Suitable fiber sources include natural fiber sources and synthetic fiber sources. The fiber source may be individual, or may be combinations of soluble fibers. Individual fiber sources having favorable solubility properties are favored and include soluble corn fiber and polydextrose. Other less soluble-favorable sources include acacia, dextrin, hydrolyzed gar, and modified starch. These latter sources readily combine with the more favorable solubility sources to modify physical properties of the embodiments as may be selectively desired. Fiber source combinations include for example but not limiting soluble corn fiber with polydexrose, soluble corn fiber with acacia, soluble corn fiber with dextrin, soluble corn fiber with hydrolyzed gar, and soluble corn fiber with modified starch; polydextrose with acacia, polydextrose with dextrin, polydextrose with hydrolyzed gar, and polydextrose with modified starch, as well as polydextrose with soluble corn fiber.

A preservative may optionally be mixed with the liquid beverage concentrate depending upon the particular soluble fiber. Acid hydrolysis reduces some fiber sources to simpler carbohydrate and thus reduce the effective activity of the soluble fiber. Such reduction may in alternate embodiments may be mitigated by buffering the pH of the concentrate at 4.5 or higher. Suitable preservatives include sodium benzoate, potassium sorbate, polylysine, propylene glycol, and methylparaben.

Sodium benzoate may be useful in formulations having a low pH, such as about 4.5 and below, preferably about 2.5-4.0 pH, but preferably used in low concentrations of about 0.1% to 0.2% w/w, while providing activity spectrum against yeasts, molds and bacteria.

Potassium sorbate may be useful in formulations of higher pH, such as 6.5 and below, and provides good water solubility but may be unstable at elevated temperatures (38° C.) or in strong light, with an activity spectrum against molds and yeasts primarily.

Polylysine may be useful in high temperature, high pH products with a broad spectrum antimicrobial activity that results from a strong cationic charge, and readily dissolves in water with minimal effect on taste and odor. Polylysine may work synergistically with other preservatives while providing temperature differences stability and pH tolerance across a range from weak acidic to weak alkaline.

Propylene glycol provides activity against bacteria and fungi, and while miscible with water, required higher levels of use concentration.

Methylparben provides an activity spectrum against fungi and gram-positive bacteria but relatively poor activity against pseudomonads. While having broad pH range, methylparben is poorly water soluble and is incompatible with nonionic and cationic surfactants.

Alternatively, reduced preservative content may be obtained through mechanical actions including controlled water activity, pasteurization and heat processing, and pH control. Controlled water activity may be attained with high concentration of fiber or other dissolved solids that reduce water activity. High temperature processing and pasteurization of the concentrate may be appropriate for tolerant fiber sources. Low pH of particular preferred embodiments provides a tart flavor upon dilution and may assist with preventing or inhibiting microbial growth.

It is to be further appreciated that a high concentration of soluble fiber and solids reduces water activity and reduces a need for a discrete preservative. Further, container materials may provide a preservative effect on contents.

An alternate embodiment may include a stabilizer, such as alpha-cyclodextrin or gum acacia.

An alternate embodiment may include a binder, such as amorphophallus propol plant fibers and/or emulsifiers.

Compositions useful in accordance with the present invention may be prepared in liquid beverage concentrates for dilution in a supply of drinking water of between about 4 and 16 ounces of water, preferable about 8 ounces of drinking water. The compositions are provided in an aqueous carrier of a volume of between about 5 and 10 ml per dose for mixing in the diluent water for consumption.

Table 1 presents representative examples of the flavored, fiber-enriched, liquid beverage concentrate composition of the present invention.

TABLE 1

| | Example 1 | Example 2 | Example 3 | Example 4 |
|---|---|---|---|---|
| Ingredient | Amount (grams) | | | |
| Soluble fiber | 3.00 | 3.00 | 2.50 | 2.50 |
| Preservative | 0.01 | 0.01 | 0.01 | 0.01 |
| Acidulant | 0.30 | 0.20 | 0.30 | 0.23 |
| Sweetener | 0.22 | 0.11 | 0.22 | 0.10 |
| Flavor | qs | qs | qs | qs |
| Color | qs | qs | qs | qs |
| Water | <1.48 | <1.68 | <1.97 | <2.16 |
| Total | 5.00 | 5.00 | 5.00 | 5.00 |

Fiber-enriched, liquid beverage concentrate compositions consistent with Examples 1-4 were evaluated:

| Fiber Source | Results |
|---|---|
| Soluble corn fiber - 1 | Clear, stable, low flavor |
| | impact |
| Polydextrose - 1 | Clear, stable, low flavor |
| | impact |
| Soluble corn fiber with polydextrose | Clear, stable, low flavor |
| | impact |
| Soluble corn fiber with acacia | Slight haze initially, |
| | falls out after 4 days |
| Soluble corn fiber with dextrin | Hazy |
| Soluble corn fiber with hydrolyzed guar | Hazy |
| Soluble corn fiber with modified starch | Hazy |
| Polydextrose with acacia | Clear initially, falls |
| | out after 24 hours |
| Polydextrose with dextrin | Hazy |
| Polydextrose with hydrolyzed guar | Hazy |
| Polydextrose with modified starch | Hazy |
| Soluble corn fiber - 1 | Clear, stable, low flavor |
| | impact |
| Polydextrose - 1 | Clear, stable, low flavor |
| | impact |

Example 5 in Table 2 below provides a base formulation that modifies Example 1 to provide a lower fiber percentage for the fiber-enriched, liquid beverage concentrate composition.

TABLE 2
Example 5

| | | | Composition | |
|---|---|---|---|---|
| | Amount | Amount | (diluted to 12 | Amount (% |
| Ingredient | (% w/w) | (grams) | oz. (350 g)) | as diluted) |
| Soluble fiber | 50.00 | 2.50 | 2.50 | 0.714 |
| Preservative | 0.20 | 0.01 | 0.01 | 0.003 |
| Acidulant | 4.60 | 0.23 | 0.23 | 0.065 |
| Sweetener | 2.00 | 0.10 | 0.10 | 0.029 |
| Flavor | qs | qs | qs | |
| Color | qa | qs | qs | |
| Water | 43.20 | 2.16 | 2.16 | 0.617 |
| Added Water | | | 345.00 | 98.571 |
| Total | 100.00 | 5.00 | 350.00 | 100.00 |

Fiber-enriched, liquid beverage concentrate compositions according to Example 5 may use citric acid as the acidulant which allows adjusting the pH into a range of about 2.0 to about 3.0. Potassium sorbate may be added to protect from microbial growth.

TABLE 3
Example 6

| | | | Composition | |
|---|---|---|---|---|
| | Amount | Amount | (diluted to 12 | Amount (% |
| Ingredient | (% w/w) | (grams) | oz (350 g)) | as diluted) |
| Soluble fiber | 66.66 | 4.00 | 4.00 | 1.14 |
| Preservative | 0.17 | 0.01 | 0.01 | 0.003 |
| Acidulant | 3.83 | 0.23 | 0.23 | 0.065 |
| Sweetener | 1.67 | 0.10 | 0.10 | 0.029 |
| Flavor | qs | qs | qs | |
| Color | qa | qs | qs | |
| Water | 27.67 | 1.66 | 1.67 | 0.477 |
| Added Water | | | 344.00 | 98.286 |
| Total | 100.00 | 6.00 | 350.00 | 100.00 |

Example 6 described in Table 3 below provides a higher amount of soluble fiber in the concentrate than that provided in the embodiment of Example 5. The concentrate may include additional water for viscosity flow of the concentrate from a container when diluting with added water.

TABLE 4

| | Example 7 | Example 8 |
|---|---|---|
| | Amount % | Amount % |
| Ingredient | (% w/w) | (% w/w) |
| Soluble corn fiber 70% | 75.00 | |
| (PROMITOR 70L available | | |
| from Tate & Lyle) | | |
| Polydextrose | | 75.00 |
| Potassium Sorbate, NF | 0.075 | 0.075 |
| Potassium Benzoate, NF | 0.20 | 0.20 |
| Citric Acid, anhydrous, USP | 1.00 | 1.00 |
| Water | 23.725 | 23.725 |
| Total | 100.00 | 100.00 |

These examples each provide an unflavored soluble fiber concentrate.

The resulting fiber-enriched, liquid beverage concentrate yielded a uniform clear liquid having a light amber color and a visually slight viscosity and a pH of about 2.0 to 3.0, which concentrate dispersed quickly in a diluent water container with little or no mixing.

TABLE 5
Example 9
Black Cherry Flavor

| | | | Composition | |
|---|---|---|---|---|
| | Amount | Amount | (diluted to 12 | Amount (% |
| Ingredient | % (w/w) | (grams) | oz (350 g)) | as diluted) |
| Soluble corn fiber | 63.54 | 3.177 | 3.177 | 0.908 |
| Black cherry flavor | 0.77 | 0.0385 | 0.0385 | 0.011 |
| Citric Acid | 5.00 | 0.250 | 0.250 | 0.071 |
| Coloring (w/v) | 2.84 | 0.142 | 0.142 | 0.041 |
| Sweetener | 0.49 | 0.0245 | 0.0245 | 0.007 |
| Water | 27.35 | 1.368 | 1.368 | 0.392 |
| Added Water | | | 345.00 | 98.57 |
| Total | 100.00 | 5.00 | 350.00 | 100.00 |

Example 9 illustrates a black cherry flavored, fiber-enriched, liquid beverage concentrate composition consistent with Example 6.

An alternate embodiment of Example 9 includes a preservative comprising potassium sorbate in an amount of 0.10 (w/w).

The resulting flavored fiber-enriched, liquid beverage concentrate in the alternate embodiment yielded a uniform transparent purple (dark reddish purple) liquid having a visually slight viscosity with a pH of about 1.43, which concentrate dispersed quickly in a diluent water container with little or no mixing. The concentrate tested to a Brookfield Viscosity (Spindle LV2@30 RPM@25° C.) of about 35 cps and a specific gravity of about 1.243.

TABLE 6
Example 10
Orange Tangerine Flavor

| | | | Composition | |
|---|---|---|---|---|
| | Amount | Amount | (diluted to 12 | Amount (% |
| Ingredient | % (w/w) | (grams) | oz (350 g)) | as diluted) |
| Soluble corn fiber | 63.59 | 3.180 | 3.180 | 0.908 |
| Natural orange | 1.24 | 0.062 | 0.062 | 0.018 |
| tangerine flavor | | | | |
| Citric Acid | 6.00 | 0.300 | 0.300 | 0.085 |
| Coloring (w/v) | 1.48 | 0.075 | 0.075 | 0.021 |
| Sweetener | 0.46 | 0.023 | 0.023 | 0.007 |
| Water | 27.23 | 1.36 | 1.36 | 0.389 |
| Added Water | | | 345.00 | 98.57 |
| Total | 100.00 | 5.00 | 350.00 | 100.00 |

Example 10 provides an orange tangerine flavored, fiber-enriched, liquid beverage concentrate composition that differs from Example 5 by changing the acidulant and sweetener to increase tartness.

An alternate embodiment of Example 10 includes a preservative comprising potassium sorbate in an amount of 0.10 (w/w).

The resulting flavored fiber-enriched, liquid beverage concentrate in the alternate embodiment yielded a uniform translucent orange (medium) liquid having a visually slight viscosity and a pH of about 1.41, which concentrate dispersed quickly in a diluent water container with little or no mixing. The concentrate tested to a Brookfield Viscosity (Spindle LV2@30 RPM@25° C.) of about 35 cps and a specific gravity of about 1.245.

In an embodiment of the present invention, the beverage concentrate is a flavored, fiber-enriched liquid beverage concentrate formulated to contain a soluble fiber comprising about 20 to 60 percent by weight of the beverage concentrate with a pH in a range of about 1.2 to about 4.0, and further comprising an acidulant of citric acid in a range of about 1% w/w to about 7% w/w, preferably about 2% w/w to about 6% w/w, and more preferably about 4% w/w to about 6% w/w, and further including a flavor and optionally a sweetener.

TABLE 7
Example 11

| | Amount |
|---|---|
| Ingredient | % (w/w) |
| PROMITOR 70L soluble corn fiber | 66.67 (33) |
| (dietary fiber) | |
| Natural orange tangerine flavor | 1.08 |
| Citric Acid | 5.24 |
| Coloring (w/v) | 1.29 |
| Sweetener | 0.40 |
| Potassium Sorbate | 0.10 |
| Water | 25.22 |
| Total | 100.00 |

Example 11 provides an orange tangerine flavored, fiber-enriched, liquid beverage concentrate composition.

A 100 ml container of the flavored, fiber enriched, liquid beverage concentrate of Example 11 provides approximately 13.3 doses per container (7.5 ml per dose) with 3.16 grams soluble fiber per serving, provided in an 8 ounce diluent supply of drinking water.

Table 8 below provides ranges for the constituent ingredients of the flavored, fiber-enriched, liquid beverage concentrate composition in varying embodiments of the present invention. It is to be appreciated that the embodiments having a relatively higher concentration of soluble fiber dissolve in a smaller amount of diluent carrier water. While such embodiments may have increased viscosity, it is believed that the liquid beverage concentrate may nevertheless dispense from a container as a flowable stream under at least squeezing pressure applied by a user to the container. It is expected that embodiments with a relatively lower concentration of soluble fiber flow more readily as a stream from the container. The flavored, fiber-enriched, liquid beverage concentrate composition readily mixes with a supply of a diluent drinking water for consumption of the soluble fiber which supply is a volume selected as appropriate for the user. A supply of diluent drinking water may be such as carried in an exercise drinking bottle holding a reasonably drinkable quantity of water such as between about 4 ounces of water to about 12 ounces of water, more preferably between about 6 ounces of water to about 10 ounces of water, and preferable about 8 ounces of water, selectively by the user, while providing 2.00 to about 4.50 grams of soluble fiber, preferably about 2.50 to about 3.50 grams of soluble fiber, and more preferably about 2.50 to about 3.00 grams of soluble fiber.

TABLE 8
Constitute Embodiments Of Flavored, Fiber-Enriched,
Liquid Beverage Concentrate Composition

| | Amount |
|---|---|
| Ingredient | (% w/w) |
| Soluble fiber | 20.00-60.00 |
| Preservative | 0.01-0.30 |
| Acidulant | 4.00-8.00 |
| Sweetener | 0.10-3.00 |
| Flavor | qs |
| Color | qa |
| Water | 28.70-75.89 |
| Total | 100.00 |

Generally, the constituents of the flavored, fiber-enriched, liquid beverage concentrate composition are added into the water sequentially as follows: preservative (if any), sweetener, soluble fiber containing dietary fiber, flavoring, coloring, and acidulant. The preparation procedure may be as follows:
charge the formulation quantity of water into a suitable mixing vessel;
add preservative (if any) and mix to dissolve;
add sweetener and mix to dissolve;
add flavoring and mix;
add coloring (if any) and mix;
add soluble fibers and mix until uniform;
add acidulant and mix until uniform and clear.

The acidulate, such as citric acid, is added after the other ingredients have been dissolved and the mixture is uniform. Early addition may cause poorly-soluble ingredients, such as benzoic acid or sorbic acid if present, to drop out of solution and re-dissolving may require application of heat.

The sweetener preferably is a low-calorie, high sweetness ingredient. While a sweetness/tartness profile available from compositions according to the present invention is broad, the fiber-enriched, liquid beverage concentrate may be diluted to about 8.0 fluid ounces+/−about 4.0 ounces common to conventional water bottles associated with persons who participate in a variety of exercise regimes while maintaining an acceptable flavor profile during use of the composition. A starting point for sweetness targeting may be about 12° brix sugar solution at the 12 ounce dilution (one degree Brix is 1 gram of sucrose in 100 grams of solution and represents the strength of the solution as percentage by mass.)

The fiber-enriched, liquid beverage concentrate according to the present invention provides soluble fiber as a nutritional supplement having a satisfactory mouthfeel while being readily dispensable as a flowable stream from a container with a visual viscosity yet dispersible in water to yield a uniform clear, transparent, or translucent dilution drinkable source of soluble fiber, and may readily be flavored for taste satisfaction. The fiber weight ranges from about 20% w/w to about 60% w/w, preferably about 26% w/w/to about 43% w/w, while providing between about 2.5 grams soluble fiber per serving to about 4 grams soluble fiber per serving, preferably between about 2.5 and 3.5 grams soluble fiber per serving, and more preferably about 3.0 grams soluble fiber per serving, with a viscosity of the flavor enriched liquid beverage concentrate of about 10 cp to about 100 cp, preferably about 25 cp to 85 cp, and more preferably about 40 cp to 70 cp. The compositions may be packaged for multiple serving doses or single serving dose. The compositions further are stable during ordinary storage and shipping of containers such that the soluble fibers remain in solution for a commercially practical period and in temperatures typically experienced for commercial nutritional products.

While the invention is described in preceding detailed description with reference to specific exemplary embodiments thereof, it will be appreciated that various modifications and changes may be made thereto without departing from the broader spirit and scope of the invention as set forth in the appended claims. The specification is, accordingly, to be regarded as illustrative rather than restrictive.

What is claimed is:

1. A flavored, fiber-enriched liquid beverage concentrate, comprising an acidulant, a flavor, a high-intensity sweetener, a dietary fiber, and water, the dietary fiber comprising about 20 to 60 percent by weight of the concentrate volume with a pH in a range of about 1.2 to about 4.0.

2. The beverage concentrate as recited in claim 1, wherein the dietary fiber comprises about 50 percent by weight of the concentrate volume.

3. The beverage concentrate as recited in claim 1, wherein the dietary fiber comprises about 33 percent by weight of the concentrate volume.

4. The beverage concentrate as recited in claim 1, wherein the concentrate volume is about 5 to 10 ml per serving.

5. The beverage concentrate as recited in claim 1, wherein the acidulant comprises about 4 to about 8 percent by weight of the concentrate volume.

6. The beverage concentrate as recited in claim 1, wherein the acidulant comprises about 6 percent by weight of the concentrate volume.

7. The beverage concentrate as recited in claim 1, wherein the volume of the acidulant provides the beverage concentrate with a pH of about 1.5 to about 3.5.

8. The beverage concentrate as recited in claim 1, wherein the volume of the acidulant provides the beverage concentrate with a pH of about 1.5.

9. The beverage concentrate as recited in claim 1, wherein the dietary fiber comprises between about 2.5 and 4 grams by weight per serving of the concentrate beverage.

10. The beverage concentrate as recited in claim 1, wherein the dietary fiber comprises about 3 grams by weight of the concentrate beverage.

11. The beverage concentrate as recited in claim 1, wherein the dietary fiber is selected from the group comprising corn fiber, polydextrose, and acacia.

12. The beverage concentrate as recited in claim 1, wherein the dietary fiber comprises corn fiber.

13. The beverage concentrate as recited in claim 1, further comprising a preservative.

14. The beverage concentrate as recited in claim 12, wherein the preservative is selected from the group comprising sodium benzoate, potassium sorbate, polylysine, propylene glycol, methylapaben, or mixtures thereof.

15. The beverage concentrate as recited in claim 12, wherein the preservative is about 0.01 to about 0.3 percent by weight of the beverage concentrate.

16. The beverage concentrate as recited in claim 12, wherein the preservative is about 0.1 percent by weight of the beverage concentrate.

17. The beverage concentrate as recited in claim 1, wherein the acidulant comprises citric acid.

18. The beverage concentrate as recited in claim 1, wherein the concentrate has a viscosity of between about 25 and 70 cp (Brookfield Viscosity (Spindle LV2@30 RPM@25° C.)).

19. The beverage concentrate as recited in claim 1, wherein the concentrate has a viscosity of about 30 cp (Brookfield Viscosity (Spindle LV2@30 RPM@25° C.)).

20. The beverage concentrate as recited in claim 1, further comprising a buffering agent for adjusting the pH of the beverage concentrate to a selected pH in a range of between 1.2 pH and 4.0 pH.

21. The beverage concentrate as recited in claim 1, wherein the soluble fiber comprises a mixture of a first fiber type and a second fiber type.

22. The beverage concentrate as recited in claim 21, wherein the first fiber type comprises corn fiber and the second fiber type comprises dextrose.

23. A method of delivering a soluble fiber for a nutritional supplement for persons, comprising the steps of:
(a) providing a beverage concentrate according to claim 1; and
(b) admixing the beverage concentrate with water to a volume in a range of about 6 ounces to about 20 ounces.

24. The method as recited in claim 23, wherein the volume is about 8 ounces.

25. The method as recited in claim 23, further comprising the step of pasteurizing of the beverage concentrate.

26. The method as recited in claim 23, further comprising the step of adjusting the pH of the beverage concentrate with a buffering agent to a selected pH in a range of between 1.2 pH and 4.0 pH.

27. The method as recited in claim 23, further comprising the step of adjusting the viscosity of the beverage concentrate to a range between about 25 cp and 75 cp (Brookfield Viscosity (Spindle LV2@30 RPM@25° C.)).

28. The method as recited in claim 23, further comprising the step of mixing as the dietary fiber a first fiber type and a second fiber type.

29. The method as recited in claim 28, wherein the first fiber type comprises corn fiber and the second fiber type comprises dextrose.

30. The method as recited in claim 23, wherein the dietary fiber comprises about 50 percent by weight of the concentrate volume.

31. The method as recited in claim 23, wherein the dietary fiber comprises about 33 percent by weight of the concentrate volume.
